(19) United States
(12) Patent Application Publication
(10) Pub. No.: US 2015/0330636 A1
(43) Pub. Date: Nov. 19, 2015

(54) SYSTEM AND METHOD FOR CONTROL OF COMBUSTION DYNAMICS IN COMBUSTION SYSTEM

(71) Applicant: General Electric Company, Schenectady, NY (US)

(72) Inventors: Sarah Lori Crothers, Greenville, SC (US); Charlotte Cole Wilson, Roebuck, SC (US); Bryan Wesley Romig, Simpsonville, SC (US)

(73) Assignee: General Electric Company, Schenectady, NY (US)

(21) Appl. No.: 14/276,700

(22) Filed: May 13, 2014

(51) Int. Cl. F23R 3/34; F02C 9/26; F23R 3/28

(52) U.S. Cl. CPC F23R 3/34; F23R 3/28; F02C 9/263

(57) ABSTRACT

A system includes a gas turbine engine that includes a first combustor and a second combustor. The first combustor includes a first fuel nozzle disposed in a first head end chamber of the first combustor. The first fuel nozzle includes a first orifice configured to inject fuel into a first combustion chamber of the first combustor. The second combustor includes a second fuel nozzle disposed in a second head end chamber of the second combustor. The second fuel nozzle includes a second orifice configured to inject the fuel into a second combustion chamber of the second combustor. The second combustor also includes a second orifice plate disposed in a fuel path upstream of the second orifice. The second orifice plate is configured to help reduce modal coupling between the first combustor and the second combustor.

### BACKGROUND

The disclosed subject matter relates generally to gas turbine systems, and more particularly, to a system and method for controlling combustion dynamics, and more specifically, for reducing modal coupling of combustion dynamics.

Gas turbine systems generally include a gas turbine engine having a compressor section, a combustor section, and a turbine section. The combustor section may include one or more combustors (e.g., combustion cans) with fuel nozzles configured to inject a fuel and an oxidant (e.g., air) into a combustion chamber within each combustor. In each combustor, a mixture of the fuel and oxidant combusts to generate hot combustion gases, which then flow into and drive one or more turbine stages in the turbine section. Each combustor may generate combustion dynamics, which occur when the combustor acoustic oscillations interact with the flame dynamics (also known as the oscillating component of the heat release), to result in a self-sustaining pressure oscillation in the combustor. Combustion dynamics can occur at multiple discrete frequencies or across a range of frequencies, and can travel both upstream and downstream relative to the respective combustor. For example, the pressure and/or acoustic waves may travel downstream into the turbine section, e.g., through one or more turbine stages, or upstream into the fuel system. Certain components of the downstream turbine section can potentially respond to the combustion dynamics, particularly if the combustion dynamics generated by the individual combustors exhibit an in-phase and coherent relationship with each other, and have frequencies at or near the natural or resonant frequencies of the components. As discussed herein, “coherence” may refer to the strength of the linear relationship between two dynamic signals, and may be strongly influenced by the degree of frequency overlap between them. In the context of combustion dynamics, “coherence” is a measure of the modal coupling, or combustor-to-combustor acoustic interaction, exhibited by the combustion system. Accordingly, a need exists to control the combustion dynamics, and/or modal coupling of the combustion dynamics, to reduce the possibility of any unwanted sympathetic vibratory response (e.g., resonant behavior) of components in the turbine system.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine engine that includes a first combustor and a second combustor. The first combustor includes a first fuel nozzle disposed in a first head end chamber of the first combustor. The first fuel nozzle includes a first orifice configured to inject fuel into a first combustion chamber of the first combustor. The second combustor includes a second fuel nozzle disposed in a second head end chamber of the second combustor. The second fuel nozzle includes a second orifice configured to inject the fuel into a second combustion chamber of the second combustor. The second combustor also includes a second orifice plate disposed in a fuel path upstream of the second orifice. The second orifice plate is configured to help reduce modal coupling between the first combustor and the second combustor.

In a second embodiment, a system includes a first combustor that includes a first fuel nozzle disposed in a first head end chamber of the first combustor. The first fuel nozzle includes a first orifice configured to inject a fuel into a first combustion chamber of the first combustor. The first combustor also includes a first orifice plate disposed in a fuel path upstream of the first orifice. The first orifice plate is configured to at least partially control first combustion dynamics in the first combustor.

In a third embodiment, a method includes injecting a fuel into a first combustion chamber of a first combustor from a first orifice of a first fuel nozzle disposed in a first head end chamber of the first combustor, injecting the fuel into a second combustion chamber of a second combustor from a second orifice of a second fuel nozzle disposed in a second head end chamber of the second combustor, and controlling second combustion dynamics in the second combustor with a second orifice plate disposed in a fuel path upstream of the second orifice, wherein the second orifice plate is configured to help reduce modal coupling between the first combustor and the second combustor.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of a gas turbine system having a plurality of combustors with an orifice plate configured to control combustion dynamics and/or modal coupling of combustion dynamics to reduce the possibility of unwanted vibratory responses in downstream components;

FIG. 2 is a cross-sectional schematic of an embodiment of one of the combustors of FIG. 1, wherein the combustor has an orifice plate configured to control combustion dynamics and/or modal coupling of combustion dynamics to reduce the possibility of unwanted vibratory responses in downstream components;

FIG. 3 is a schematic of an embodiment of a portion of one of the combustors of FIG. 1, wherein the combustor has at least one orifice plate configured to control combustion dynamics and/or modal coupling of combustion dynamics to reduce the possibility of unwanted vibratory responses in downstream components;

FIG. 4 is a schematic diagram of a gas turbine system having a plurality of combustors each equipped with an orifice plate configured to control combustion dynamics and/or modal coupling of combustion dynamics to reduce the possibility of unwanted vibratory responses in downstream components; and

FIG. 5 is a schematic diagram of a gas turbine system having a first plurality of first combustors and a second plurality of second combustors arranged in a pattern to control combustion dynamics and/or modal coupling of combustion dynamics to reduce the possibility of unwanted vibratory responses in downstream components.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed toward reducing combustion dynamics and/or modal coupling of combustion dynamics to reduce unwanted vibratory responses in downstream components in a gas turbine system by varying geometries of one or more turbine combustors, e.g., disposing orifice plates in a fuel path upstream of a fuel nozzle. As used herein, an “orifice plate” may be defined as a plate having one or more holes, or orifices, therethrough, which limit fluid flow through the orifice plate. A gas turbine combustor (or combustor assembly) may generate combustion dynamics due to the combustion process, characteristics of intake fluid flows (e.g., fuel, oxidant, diluent, etc.) into the combustor, and various other factors. The combustion dynamics may be characterized as pressure fluctuations, pulsations, oscillations, and/or waves at certain frequencies. The intake fluid flow characteristics may include velocity, pressure, fluctuations in velocity and/or pressure, variations in flow paths (e.g., turns, shapes, interruptions, etc.), or any combination thereof. Collectively, the combustion dynamics can potentially cause vibratory responses and/or resonant behavior in various components downstream from the combustor. For example, the combustion dynamics (e.g., at certain frequencies, ranges of frequencies, amplitudes, etc.) can travel downstream in the gas turbine system. If the downstream components have natural or resonant frequencies that are driven by these pressure fluctuations (e.g., combustion dynamics), then the pressure fluctuations can potentially cause vibration, stress, fatigue, etc. The components may include turbine nozzles, turbine blades, turbine shrouds, turbine wheels, bearings, or any combination thereof. The downstream components are of specific interest, as they are more sensitive to combustion tones that are in-phase and coherent. Thus, reducing coherence specifically reduces the possibility of unwanted vibrations in downstream components.

As discussed in detail below, the disclosed embodiments may equip one or more gas turbine combustors with an orifice plate disposed in a fuel path upstream of a fuel nozzle to modify the distribution of fuel to the various fuel circuits in the combustor. A fuel circuit may include one or more fuel nozzles in the head end of the combustor. In particular, the orifice plate may alter a fuel split at an individual combustor compared to another combustor, thereby altering the fuel flow to a given fuel nozzle in the head end. A change in the fuel nozzle pressure ratio and/or equivalence ratio resulting from differences in the fuel flow rate to a given fuel nozzle or group of fuel nozzles, may directly affect the combustion instability frequency and/or amplitude in each combustor. As the frequency of the combustion dynamics in one or more combustors is driven away from that of the other combustors, coherence and, therefore, modal coupling of the combustion dynamics are reduced. As a result, various embodiments of the present invention may reduce the ability of the combustor tone to cause a vibratory response in downstream components.

The disclosed embodiments may vary the orifice plate configurations among a plurality of gas turbine combustors, thereby varying the combustion dynamics from combustor-to-combustor in a manner to reduce the combustion dynamics amplitudes and/or modal coupling of the combustion dynamics among the plurality of gas turbine combustors. For example, the changes in fuel split caused by the orifice plate configurations may result in combustor-to-combustor variations in the fuel split, and therefore, combustion dynamics frequencies, thereby reducing the possibility of modal coupling of the combustors, particularly at frequencies that are aligned with resonant frequencies of the components of the gas turbine system. Thus, by changing the effective orifice areas of the orifice plates of the plurality of gas turbine combustors, the frequencies may be shifted from combustor-to-combustor, disrupting modal coupling. In other words, by reducing the similarity of frequencies in the plurality of gas turbine combustors, the coherence may be reduced.

Accordingly, a gas turbine engine may employ a variety of orifice plate configurations to alter the fuel split of the combustor, thereby altering the combustion dynamics of the combustor and therefore mitigating unwanted vibratory responses in the gas turbine system components caused by combustion dynamics in the combustors. For example, the geometry of the orifice plate of each gas turbine combustor may include one or more angled surfaces, curved surfaces (e.g., concave surfaces, convex surfaces, constant curvatures, or varying curvatures), flat surfaces, recesses, protrusions, polygonal surfaces (e.g., triangular surfaces, pentagonal surfaces, hexagonal surfaces, or quadrilateral surfaces), stepped or zigzagging surfaces, winding surfaces, irregular surfaces (e.g., non-uniform, uneven, or asymmetrical; wavy surfaces, jagged surfaces, pointed surfaces, or serrated surfaces), or any combination thereof. However, in some embodiments, at least some (e.g., 2, 3, 4, 5, 6, 7, 8, 9, or 10) or all of the turbine combustors have different orifice plates, such as different angled orifice plates, different curved orifice plates, different flat orifice plates, different orifice configurations, or any combination thereof. In some embodiments, geometrical characteristics (e.g., height, width, depth, length, degree of angle, angle characteristics, radius of curvature, orientation of geometrical features, etc.) between orifices of the orifice plates in the fuel lines supplying different combustors may be different. Particularly, in some embodiments, combustor orifice plates associated with different combustors may have any one of different geometric shapes, different geometric characteristics, different geometric arrangements, or any combination thereof.

Accordingly, the disclosed embodiments employing one or more combustors having one or more varying orifice plates helps to vary the fuel split of one or more combustors, thereby varying the combustion dynamics within each combustor and among adjacent, or non-adjacent, combustors. The use of the disclosed embodiments helps mitigate the modal coupling of the combustors, which reduces the possibility of unwanted vibratory response in components downstream from the combustors, as well as the combustors themselves. For example, providing one or more combustors with an orifice plate in the fuel supply line with a different geometry (e.g., a different geometric shape, characteristic, or arrangement) compared to one or more of the other combustors, may provide a different fuel split from combustor-to-combustor, thereby altering the combustion dynamics from combustor-to-combustor, reducing the possibility of coherent behavior of the combustors of the gas turbine system.

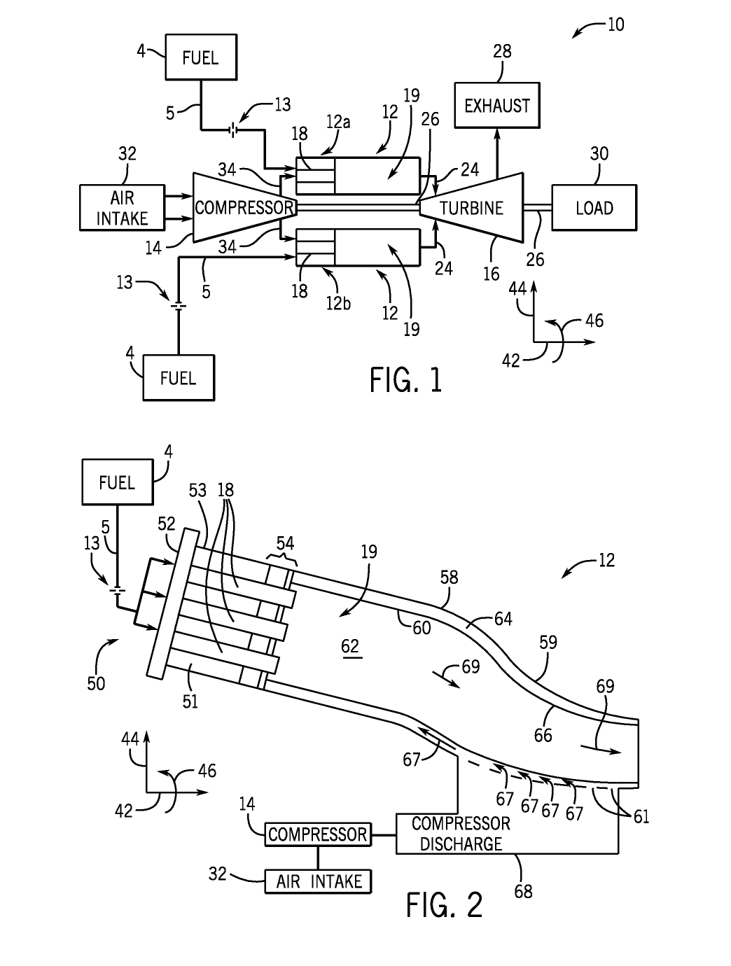

With the foregoing in mind, FIG. 1 is a schematic of an embodiment of a gas turbine system 10 having a plurality of combustors 12, wherein one or more combustors 12 is equipped with a combustor orifice plate 13 having a configuration and/or a geometry different from the combustor orifice plate 13 of at least one other combustor 12. It should be noted that in certain embodiments, not all combustors 12 have the combustor orifice plate 13. As discussed below, the orifice plate 13 may be disposed in a fuel path 5 conveying a fuel 4 to the combustor 12. In the following discussion, the fuel path 5 may refer to all or any portion of the path taken by the fuel 4 as the fuel 4 travels to where the fuel is ultimately injected into the combustor 12 to be combusted. In certain embodiments, additional orifice plates 13 may be disposed in one or more fuel circuits supplying fuel to fuel nozzles in a head end of the combustors 12. As discussed above, each orifice plate 13 includes one or more holes, or orifices, which limit the flow of the fuel 4 through the orifice plate 13. The holes in each orifice plate 13 collectively define an effective orifice area through the orifice plate 13 that determines the mass flow of fluid (e.g., the fuel 4) through the orifice plate 13 for a given differential pressure across the orifice plate 13. The effective orifice area of the orifice plate 13 is the combined area through which the fuel 4 passes and may be calculated as the total cross-sectional area of the holes in the orifice plate 13 multiplied by a coefficient of flow or discharge coefficient. The coefficient of flow may represent a ratio of the actual and theoretical maximum flows through the orifice plate 13.

In one or more of the combustors 12 shown in FIG. 1, the orifice plate 13 may have a configuration configured to change the combustion dynamics in the particular combustor 12, thereby helping to reduce any unwanted vibratory responses in components downstream of the combustor 12. For example, the orifice plate configuration may include geometrical features to change either the geometric or effective orifice area of the orifice plate, thereby changing the flow through the fuel circuit, and ultimately the fuel split in the combustor, and ultimately altering the amplitudes and frequencies of the combustion dynamics generated by a given combustor 12. In addition, the disclosed embodiments may vary the geometry of orifice plates 13 between the plurality of combustors 12 to help reduce or avoid any modal coupling of the combustion dynamics among the plurality of combustors 12, thereby helping to reduce any unwanted vibratory response of gas turbine components downstream of the plurality of combustors 12. For example, the disclosed embodiments may vary the geometric shape (e.g., angled, curved, stepped, concave, convex, or flat), the geometric characteristics (e.g., height, width, depth, length, degree of angle, angle characteristics, radius of curvature, distance between orifices), the geometric arrangements (e.g., regular, irregular, etc.), or any combination thereof, of the orifice plates 13 among the plurality of combustors 12. As a result, the non-uniform geometrical configuration of orifice plates 13 among the combustors 12 may help to vary the combustion dynamics frequency from one combustor 12 to another. Thus, the combustion dynamics generated by the plurality of combustors 12 are less likely to result in coherent behavior that could potentially cause unwanted vibratory responses in the gas turbine system 10.

In the illustrated embodiment, the turbine system 10 has a plurality of combustors 12 (e.g., 12a and 12b) with one or more of the combustors 12 equipped with one or more orifice plate 13 disposed in the fuel path 5. These orifice plates 13 may vary from one combustor 12 to another, such as in a number, arrangement, diameter, shapes, total effective orifice areas, or any combination thereof, of the orifice(s) present in the orifice plate 13. In this manner, the geometric arrangement of adjacent orifice plates 13 may be varied, thereby reducing modal coupling of the combustors, and therefore, any undesirable vibratory responses in downstream components. In some embodiments, the geometry of the orifice plates 13 may be altered in geometric shape, characteristic, and/or arrangement from one combustor 12 to another. In certain embodiments, the orifice plates 13 are not different in each combustor 12 and/or each combustor 12 does not have the orifice plate 13 disposed in the fuel circuit providing the fuel 4 to the combustor 12. In the disclosed embodiments, the one or more orifice plates 13 of a subset, or group of combustors 12, is different from the one or more orifice plates 13 of another subset, or another group of combustors 12. A subset or group may include one or more combustors 12, and there may be any number of groups or subsets of combustors 12 (e.g., 2, 3, 4, 5, 6, or more) up to the number of combustors 12 included in the gas turbine system 10.

The gas turbine system 10 includes a compressor 14, one or more combustors 12 with the orifice plates 13 disposed in the fuel path 5, and a turbine 16. One or more of the gas turbine combustors 12 may include the orifice plate 13 disposed in the fuel path 5, which may be configured to direct the flow of the fuel 4, or mixtures of the fuel 4 with other materials, from a source of the fuel 4 to one or more fuel nozzles 18 (e.g., 1, 2, 3, 4, 5, 6, or more). For example, the orifice plate 13 is configured to route the fuel 4 from the source of the fuel 4 and into a respective combustion chamber 19 via the fuel nozzles 18 (e.g., using an inner vane orifice, an outer vane orifice, a pilot orifice, a diffusion orifice, or any combination thereof, of the fuel nozzles 18), as is described further in FIG. 2. The gas turbine combustors 12 ignite and combust a pressurized oxidant (e.g., air) and fuel mixture (e.g., a mixture of air with the fuel 4) within the combustion chambers 19, and then pass resulting hot pressurized combustion gases 24 (e.g., exhaust) into the turbine 16. In particular, varying the geometry of the orifice plate 13 may vary the flow rate of the fuel 4 routed from the source of the fuel 4 to the combustion chamber 19. Further, varying the flow rate to one or more fuel circuits (via the fuel flow path 5) to one or more combustors 12 may vary, adjust, or change the fuel split to one or more combustors 12, and therefore, the combustion dynamics within the combustion chamber 19 of one or more combustors 12. Varying the combustion dynamics, specifically the frequency, in one or more combustors 12 compared to the remaining combustors 12, may reduce the possibility of modal coupling between the combustors 12, and thus may reduce unwanted vibratory responses in the downstream components.

Turbine blades within the turbine 16 are coupled to a shaft 26 of the gas turbine system 10, which may also be coupled to several other components throughout the turbine system 10. As the combustion gases 24 flow against and between the turbine blades of the turbine 16, the turbine 16 is driven into rotation, which causes the shaft 26 to rotate. Eventually, the combustion gases 24 exit the turbine system 10 via an exhaust outlet 28. Further, in the illustrated embodiment, the shaft 26 is coupled to a load 30, which is powered via the rotation of the shaft 26. The load 30 may be any suitable device that generates power via the torque of the turbine system 10, such as an electrical generator, a propeller of an airplane, or other load.

The compressor 14 of the gas turbine system 10 includes compressor blades. The compressor blades within the compressor 14 are coupled to the shaft 26, and will rotate as the shaft 26 is driven to rotate by the turbine 16, as discussed above. As the compressor blades rotate within the compressor 14, the compressor 14 compresses air (or any suitable oxidant) received from an air intake 32 to produce pressurized air 34 (e.g., pressurized oxidant). The pressurized air (e.g., pressurized oxidant) 34 is then fed into the fuel nozzles 18 of the combustors 12. As mentioned above, the fuel nozzles 18 mix the pressurized air (e.g., pressurized oxidant) 34 and the fuel 4 to produce a suitable mixture ratio for combustion. In the following discussion, reference may be made to an axial direction or axis 42 (e.g., a longitudinal axis) of the combustor 12, a radial direction or axis 44 of the combustor 12, and a circumferential direction or axis 46 of the combustor 12.

FIG. 2 is a cross-sectional view of an embodiment of one of the combustors 12 of FIG. 1, including the orifice plate 13 disposed in the fuel path 5. The combustor 12 includes a head end 50, an end cover 52, a combustor cap assembly 54, and the combustion chamber 19. The head end 50 of the combustor 12 generally encloses the cap assembly 54 and fuel nozzles 18 in a head end chamber 51 positioned axially between the end cover 52 and the combustion chamber 19. The combustor cap assembly 54 generally contains the fuel nozzles 18. The fuel nozzles 18 route the fuel 4, oxidant, and sometimes other fluids to the combustion chamber 19. In certain embodiments, the fuel path 5 may divide into separate fuel paths to each respective fuel nozzle 18 or fuel paths that supply various regions of all fuel nozzles 18 in one or more groups of fuel nozzles 18 of the combustor 12, as shown in FIG. 2. For example, each fuel nozzle 18 may have a plurality of orifices through which the fuel 4 may be injected into the combustion chamber 19. The plurality of orifices may be disposed in different locations along the fuel nozzle 18 and/or may have different characteristics (e.g., diameters) from one another. For example, certain orifices of the fuel nozzle 18 may be selectively used during startup, normal operation, reduced rate operation, and so forth. Other orifices of the fuel nozzle 18 may be used to alter the combustion dynamics of the combustor 12. In certain embodiments, a particular fuel circuit, which is part of the overall fuel path 5, may be used to route the fuel 4 to a particular type of orifice for each of the plurality of fuel nozzles 18. Thus, a plurality of fuel circuits may be used to route the fuel 4 to the plurality of orifices for each of the plurality of fuel nozzles 18.

In certain embodiments, it may be advantageous to maintain approximately the same total fuel flow rate to each of the plurality of combustors 12. The total fuel flow rate may represent the sum of the fuel flow rates injected by each of the plurality of fuel nozzles 18 for a particular combustor 12. As discussed in further detail below, the orifice plates 13 may be used to maintain approximately the total fuel flow rate for each of the plurality of combustors 12. For example, if orifice plates 13 are disposed in the fuel flow path 5 (e.g., fuel circuit) of a first group of combustors 12, then orifice plates 13 may be disposed in the fuel flow path 5 (e.g., fuel circuit) of a second group of combustors 12, to help maintain the same total fuel flow rate to the combustors 12, while still changing the fuel split at the combustor-level, and therefore controlling the frequency (combustion dynamics) at the combustor-level, in order to induce a frequency difference, and therefore, reduced coherence or modal coupling of the combustion system. Other arrangements of the orifice plates 13 are possible and are described in detail below.

The combustor 12 has one or more walls extending circumferentially 46 around the combustion chamber 19 and the axis 42 of the combustor 12, and generally represents one of a plurality of combustors 12 that are disposed in a spaced arrangement circumferentially about a rotational axis (e.g., shaft 26) of the gas turbine system 10. In certain embodiments, the geometry of the orifice plates 13 may vary between two or more (or all) of the combustors 12 to vary the fuel split and therefore, the combustion dynamics among the combustors 12. For example, orifice plates 13 in different combustors 12, may include differences in geometric shape, geometric characteristics, and/or geometric arrangements of the plate and/or orifice(s) of the plate. Specifically, the variability in orifice plates 13, as discussed in detail below, helps to vary the fuel split, and therefore, the combustion dynamics between two or more of the plurality of combustors 12, such that the combustion dynamics frequency, and possibly amplitude of each combustor 12 is different from at least one other combustor 12 within the gas turbine system 10. In this manner, the variability in orifice plates 13 helps to reduce unwanted vibratory responses in the gas turbine system 10, and therefore, minimizes vibrational stress, wear, and/or performance degradation of the gas turbine system 10.

In the illustrated embodiment, one or more fuel nozzles 18 are attached to the end cover 52, and pass through the combustor cap assembly 54 to the combustion chamber 19. For example, the combustor cap assembly 54 contains one or more fuel nozzles 18 (e.g., 1, 2, 3, 4, 5, 6, or more) and may provide support for each fuel nozzle 18. The combustor cap assembly 54 is disposed along a portion of the length of the fuel nozzles 18, housing the fuel nozzles 18 within the combustor 12. Each fuel nozzle 18 facilitates the mixing of pressurized oxidant and fuel (e.g., fuel 4) and directs the mixture through the combustor cap assembly 54 into the combustion chamber 19. The oxidant-fuel mixture may then combust in a primary combustion zone 62 of the chamber 19, thereby creating hot pressurized exhaust gases. These pressurized exhaust gases drive the rotation of blades within the turbine 16.

Each combustor 12 includes an outer wall (e.g., flow sleeve 58) disposed circumferentially about an inner wall (e.g., combustor liner 60) to define an intermediate flow passage or space 64, while the combustor liner 60 extends circumferentially about the combustion chamber 19. The inner wall 60 also may include a transition piece 66, which generally converges toward a first stage of the turbine 16. An impingement sleeve 59 is disposed circumferentially 46 about the transition piece 66. The liner 60 defines an inner surface of the combustor 12, directly facing and exposed to the combustion chamber 19. The flow sleeve 58 and/or impingement sleeve 59 may include a plurality of perforations 61, which direct an oxidant flow 67 (e.g., an airflow) from a compressor discharge 68 into the flow passage 64 while also impinging air against the liner 60 and the transition piece 66 for purposes of impingement cooling. The flow passage 64 then directs the oxidant flow 67 in an upstream direction toward the head end 50 (e.g., relative to a downstream direction 69 of the hot combustion gases), such that the oxidant flow 67 further cools the liner 60 before flowing through the head end chamber 51, through the fuel nozzles 18, and into the combustion chamber 19.

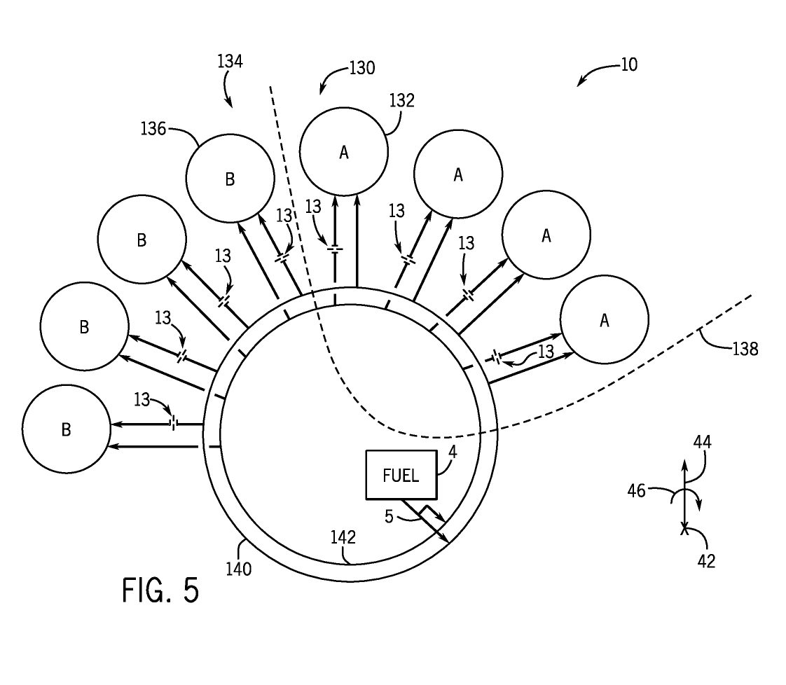

The orifice plate 13 may have a particular geometry, such as a geometric shape, characteristic, or arrangement of orifice(s), which may be configured to vary the fuel split of the combustor 12, thereby varying the combustion dynamics (e.g., pressure pulsations, fluctuations, or oscillations) within the combustor 12. For example, the head end chamber 51 is defined or bounded by the end cover 52, the combustor cap assembly 54 axially 42 offset from the end cover 52, and a wall 53 extending circumferentially 46 around the chamber 51. A geometrical change to the orifice plate 13 disposed along the fuel path 5 leading to one or more fuel nozzles 18 disposed in the chamber 51 may change the flow of the fuel 4 through the fuel nozzles 18 in the head end chamber 51, thereby altering the pressure ratio across one or more orifices through which the fuel is injected by the fuel nozzle into the combustion chamber, and also altering the local equivalence ratio of the flame for one or more fuel nozzles 18. Increasing the flow of the fuel 4 to a particular fuel nozzle (or group of fuel nozzles 18) increases the pressure ratio across one or more orifices through which fuel is injected by the fuel nozzle into the combustion chamber 19, and also increases the local equivalence ratio of the fuel nozzle(s) 18, altering the flame dynamics and therefore the combustion dynamics. Similarly, decreasing the flow of the fuel 4 to a particular fuel nozzle (or group of fuel nozzles 18) decreases the pressure ratio across one or more orifices through which fuel is injected by the fuel nozzle into the combustion chamber, and also decreases the local equivalence ratio of the fuel nozzle(s) 18, altering the flame dynamics, and therefore the combustion dynamics. Altering the fuel split in this manner alters the flame dynamics, thereby altering the combustion dynamics of the combustor 12. For example, the orifice plate 13 may result in varying the frequency, and possibly the amplitude of the combustion dynamics of one combustor 12 with respect to another. In certain embodiments, the orifice plate 13 may be modified in a manner to tune the combustor 12 to operate at a certain frequency or within a certain frequency range. In multi-combustor 12 gas turbine systems 10, a first group of combustors 12 that includes one or more combustors 12, may be equipped with an orifice plate 13 to restrict fuel flow of the fuel 4 to the one or more fuel circuits of the one or more combustors 12, that tunes the first group of combustor(s) 12 to operate at a certain frequency and/or frequency range. Additionally, one or more of the other fuel circuits of the one or more other combustors 12, that includes a second group of combustors 12, may be equipped with the orifice plate 13, which may be different from or the same as the orifice plate(s) 13 used for the fuel 4 associated with the first group of combustors 12, to restrict fuel flow of the fuel 4 to the one or more combustors 12 in the second group of combustors 12, that tunes the second group of combustors 12 to operate at a different frequency and/or frequency range. In this way, one or more combustors 12 can be tuned to operate at a different frequency when compared to one or more of the remaining combustors 12, while maintaining a similar fuel flow to each combustor 12. Maintaining a similar total fuel flow to each combustor 12 may be desirable in certain embodiments, but in other embodiments, not all the combustors 12 may have the same total fuel flow. For example, the combustors 12 may be equipped with orifice plates 13 in the fuel path 5 that alternate combustion dynamics frequency from combustor-to-combustor, gradually step up or step down the combustion dynamics frequency or randomly distribute the combustion dynamics frequency among the plurality of combustors 12. In certain embodiments, the combustors 12 may be modified in groups of one or more combustors 12 such that a group of multiple combustors 12 may produce a single combustion dynamics frequency that is different from the combustion frequency of the combustors 12 in another group (as shown in FIG. 5). Multiple groups of combustors 12, each producing its own combustion frequency, may be employed, with any desired spatial arrangement of the combustors 12 in a group (e.g., adjacent or alternating). In certain embodiments, there may be one or more combustors 12, or a group of combustors that does not have the orifice plate 13 in the fuel path 5, which may result in those combustors 12 having a frequency different from one or more groups of combustors 12 that do include the orifice plate 13.

The end cover 52 may generally be configured to route a liquid fuel, a gas fuel, and/or a blended fuel from the fuel source and into the combustion chamber 19 via one or more of the fuel nozzles 18. The gas turbine combustor 12 ignites and combusts the pressurized oxidant and fuel mixture (e.g., an oxidant-fuel mixture) within the combustion chamber 19, and then passes resulting hot pressurized combustion gases 24 (e.g., exhaust) into the turbine 16 in the downstream direction 69. In certain embodiments, varying the geometry of the orifice plate 13 (e.g., disposed upstream of the fuel nozzle 18) may vary, adjust, or change the fuel split in one or more combustors 12, and therefore, the combustion dynamics frequency of the one or more combustors 12 to achieve a combustion dynamics frequency difference among the combustors 12, and therefore, reduce unwanted vibratory responses in the gas turbine system 10.

As shown in FIG. 2, one or more orifice plates 13 may be disposed along the fuel path 5 leading to one or more fuel nozzles 18 disposed within the head end chamber 51 of the combustor 12. Specifically, the fuel nozzles 18 may be configured to inject the fuel 4 from different regions or areas of the fuel nozzle 18, such as from an inner vane fuel orifice, an outer vane fuel orifice, a pilot fuel orifice, a diffusion fuel path orifice, or any combination thereof, to adjust the characteristics of the combustion within the combustion chamber 19. For example, injecting more or less of the fuel 4 from one or more of the different regions of the fuel nozzle 18 may be used to adjust a fuel-air ratio profile across the flame, and/or the pressure ratio across one or more orifices through which fuel is injected into the combustion chamber, which alters the flame dynamics, and can also affect the composition of the combustion gases 24 produced in the combustion chamber 19 (e.g., create more or less emissions, such as CO and NOₓ). A geometrical change to the orifice plate 13 disposed along one or more fuel circuits of the fuel path 5 leading to the fuel nozzle 18 may change the flow of the fuel 4 through the combustion chamber 19, thereby altering the fuel split of the combustor 12. Thus, the orifice plates 13 leading to the fuel nozzles 18 may be used to reduce modal coupling between combustors 12.

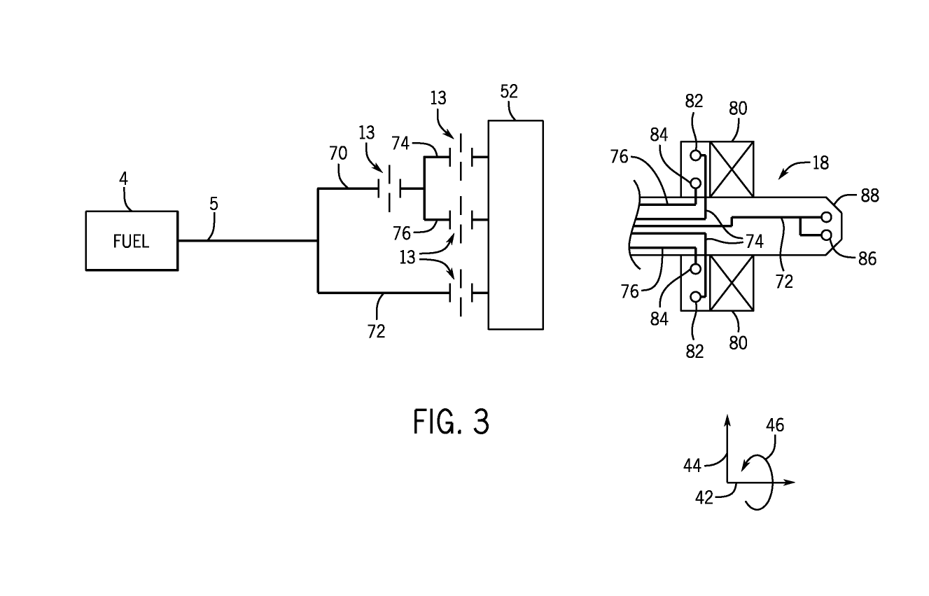

FIG. 3 is a schematic of an embodiment of a portion of one of the fuel nozzles 18 of one of the combustors of FIG. 1, including one or more orifice plates 13 disposed in the fuel path 5. For example, the fuel path 5 may be divided into a vane fuel path 70 that conveys the fuel 4 to one or more vane packs 80 (e.g., a plurality of vanes positioned at an angle to a direction of flow) of the fuel nozzle 18 and a diffusion or pilot fuel path 72 that conveys the fuel 4 to one or more diffusion or pilot orifices 86 disposed near a tip 88 of the fuel nozzle 18. The vane pack 80 may include one or more vanes to introduce a swirling motion to the flow of the fuel 4 flowing through the fuel nozzle 18. The diffusion or pilot orifices 86 may be used during certain portions of the operation of the combustor 12, such as full load, start-up, reduced-rate operation, or shut-down. In certain embodiments, one or both of the vane fuel path 70 and the diffusion or pilot fuel path 72 may include the orifice plate 13 to adjust the flow of the fuel 4 to the vane packs 80 and the diffusion or pilot orifices 86, respectively. In certain embodiments, the vane fuel path 70 may be divided into an outer vane fuel path 74 that conveys the fuel 4 to one or more outer vane orifices 82 and an inner vane fuel path 76 that conveys the fuel 4 to one or more inner vane orifices 84. In other embodiments, the fuel 4 may be conveyed to both the inner and outer vane orifices 84 and 82 by a single vane fuel path 70. As shown in FIG. 3, the outer vane orifices 82 are disposed further away from the axial axis 42 of the combustor 12 than the inner vane orifices 84. One or both of the outer vane fuel path 74 and the inner vane fuel path 76 may include the orifice plate 13 to adjust the flow of the fuel 4 to the outer and inner vane orifices 82 and 84, respectively (e.g., the split of the fuel 4 between the outer and inner vane orifices 82 and 84).

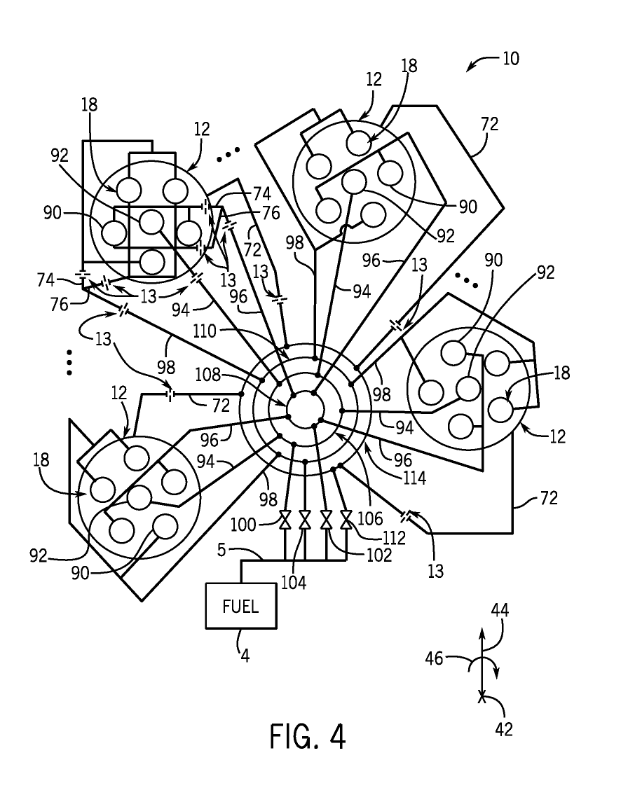

FIG. 4 is a schematic diagram of the gas turbine system 10 having a plurality of combustors 12, with one or more combustors 12 having the orifice plate 13 disposed in the fuel path 5. In the illustrated embodiment, the gas turbine system 10 includes four combustors 12 coupled to the turbine 16. However, in other embodiments, the gas turbine system 10 includes any number of combustors 12 (e.g., 1, 2, 3, 4, 5, 6, 7, 8, 9, 10, 11, 12, 13, 14, 15, 16, or more combustors). Although orifice plates 13 are shown in FIG. 4 for each of the combustors 12, in certain embodiments, not all of the combustors 12 of the gas turbine system 10 have the orifice plate 13 disposed in the fuel path 5. In certain embodiments, a subset of the combustors 12 may have the orifice plate 13 disposed in the fuel path 5, while a second subset of combustors 12 may not have the orifice plate 13 disposed in the fuel path 5. As shown in FIG. 4, each of the combustors 12 includes a plurality of outer fuel nozzles 90 arranged radially 44 around a center fuel nozzle 92. In addition, each of the fuel nozzles 90, 92 may have a circular cross-sectional shape, although other shapes, such as a truncated pie-shape, may be used in certain embodiments. In certain embodiments, the number, shape, and arrangements of the fuel nozzles 90, 92 may be different from that shown in FIG. 4 and selected to achieve a desired combustion efficiency or performance.

As shown in FIG. 4, the fuel nozzles 90, 92 may be divided into various groups or circuits to facilitate multiple fueling regimes over the range of operation of the gas turbine system 10. For example, the center fuel nozzle 92 may define a primary fuel nozzle group and may receive the fuel 4 from a center nozzle supply line 94, while the surrounding outer fuel nozzles 90 may be grouped as secondary and/or tertiary fuel nozzle groups to receive the fuel 4 (or a different fuel) from respective outer nozzle supply lines 96, 98. Thus, the nozzle supply lines 94, 96, and 98 may include all or portions of the fuel paths 70, 74, or 76 shown in FIG. 3. The illustrated embodiment shows one particular arrangement of fuel nozzles 90, 92 in which a secondary fuel nozzle group of two non-adjacent fuel nozzles 90 is supplied by the outer nozzle supply line 96 and a tertiary fuel nozzle group of three fuel nozzles 90 is supplied by the other outer nozzle supply line 98. However, in certain embodiments, other groupings of fuel nozzles 90, 92 may instead be used, including groupings that include the center fuel nozzle 92 and one or more of the outer fuel nozzles 90. In addition, as shown in FIG. 4, one or more orifice plates 13 may be disposed in the nozzle supply lines 94, 96, and/or 98 to adjust the flow rate of the fuel 4 to one or more of the combustors 12. As discussed below, these orifice plates 13 may be used to help maintain approximately the same total (e.g., sum of the various flow rates of the fuel 4 for a particular combustor 12) fuel flow rate to each of the combustors 12. The orifice plates 13 in the fuel path 5 may also alter the equivalence ratio of the primary flame zone and/or the pressure ratio of one or more of the orifices through which fuel is injected by the fuel nozzles into the combustion chamber, which may also alter the combustion dynamics amplitude and/or frequency of one or more combustors 12.

During base load operations, all of the nozzle supply lines 94, 96, and 98 may be used to supply the fuel 4 to the fuel nozzles 90, 92 in the combustors 12 (with respective nozzle supply lines 94, 96, and 98 supplying respective primary, secondary, and tertiary groupings of the fuel nozzles 90, 92). The flow of the fuel 4 may be reduced or completely eliminated from one or more groups of the fuel nozzles 90, 92 during reduced or turndown operations, as dictated by primary, secondary, and tertiary gas control valves 100, 102, and 104 coupled to corresponding primary, secondary, and tertiary fuel manifolds 106, 108, and 110. In addition, the diffusion or pilot fuel path 72 may also be used to supply the fuel 4 to one or more of the fuel nozzles 18 through the diffusion or pilot orifices 86 during base load operations, as well as reduced or turndown operations. The flow of fuel 4 through the diffusion or pilot fuel path 72 may be controlled by the diffusion or pilot fuel control valve 112.

As shown in FIG. 4, the fuel 4 is provided to one or more of the combustors 12 along the fuel path 5 through various fuel circuits (e.g. the primary, secondary, tertiary, diffusion or pilot), which may be adjusted by a primary, secondary, tertiary, and/or a diffusion or pilot fuel control valve 100, 102, 104, 112 coupled to a primary, secondary, tertiary, and/or diffusion or pilot manifold 106, 108, 110, 114. Orifice plates 13 may be disposed along individual fuel supply lines for one or more of the combustors 12. For example, one or more combustors 12 may be coupled to the diffusion or pilot manifold 114 via the diffusion or pilot fuel path 72. In certain embodiments, the combustors 12 include outer/inner vane orifices 82/84 and/or diffusion or pilot orifices 86. In such embodiments, the gas turbine system 10 may not include separate inner and outer vane fuel and diffusion or pilot fuel paths. Although the fuel nozzles 18 may include inner and outer vane orifices 84, 82, one or more fuel nozzles in the gas turbine system may not have separate inner and outer vane fuel paths 76, 74. Instead, the fuel may be routed to the inner and outer vane orifices 84, 82, by the vane path 70 (e.g. through fuel supply lines 94, 96, 98). As shown in FIG. 4, one or more of the vane fuel paths 70 (e.g., supplied by nozzle supply lines 94, 96, and/or 98) may include the orifice plate 13 and/or one or more of the diffusion or pilot fuel paths 72 may also include the orifice plate 13. It should be noted that the outer and inner vane fuel paths 74 and 76 may be fed by the outer nozzle supply lines 96 and 98, and possibly center nozzle supply line 94 in certain embodiments. In certain embodiments, the fuel flow path for the inner/outer vanes is split at the end cover 52. In certain embodiments, at least one of the vane fuel paths 70 includes the orifice plate 13 and/or at least one of the diffusion or pilot fuel paths 72 includes the orifice plate 13. In addition, in certain embodiments, one or more of the combustors 12 may not include the orifice plate 13 in either the vane fuel path 70 or the diffusion or pilot fuel path 72. In other words, reduction of modal coupling between the combustors 12 may be achieved without all of the fuel paths 70 and 72 having the orifice plate 13. Further, as discussed above, the orifice plates 13 may include one or more differences from one another. However, in certain embodiments, the orifice plates 13 used in the gas turbine system 10 may not be different from one another. For example, orifice plates 13 may be disposed in the fuel path 5 for a first group of combustors 12, and a second group of combustors 14 may not include any orifice plates 13. In such embodiments, although the orifice plates 13 may be similar to one another, the placement of the orifice plates 13 in the gas turbine system 10 may help reduce combustion dynamics and/or modal coupling of combustion dynamics in the gas turbine system 10.

The effective orifice area for each orifice plate 13 may be substantially different for the fuel paths 72, 74, and 76 and the nozzle supply lines 94, 96, and 98 when orifice plates 13 are used for the fuel 4 based on the desired difference, or bias, in the fuel splits from one combustor 12 (e.g., a first combustor) to another combustor 12 (e.g., a second combustor). In certain embodiments, fuel path 70 may be connected to the outer nozzle supply lines 96 and 98, and in some cases also to the center nozzle supply line 94. Changing the fuel split between the combustors 12 using the orifice plates 13 directly affects the frequency and/or amplitude of the combustion dynamics, and changing the frequency in one or more combustors 12 compared to the other combustors 12 may reduce coherence and, therefore, modal coupling of combustion dynamics.

In the illustrated embodiment shown in FIG. 4, for example, the effective orifice area of at least one of the orifice plates 13 disposed in one of the vane fuel paths 70 (or diffusion or pilot fuel path 72) is substantially different from the effective orifice area of another orifice plate 13 disposed in another vane fuel path 70 (or diffusion or pilot fuel path 72). In one embodiment, at least one of the effective orifice areas of the orifice plates 13 is substantially different between two or more combustors 12 to produce a difference in combustion dynamics frequencies between two or more combustors 12. Alternately, in certain embodiments, orifice plates 13 may be disposed in the fuel path 5 for a subset of combustors 12. Further, there may be a second set of combustors 12 with no orifice plates 13 disposed in the fuel flow path 5. Further, while reference is made to individual combustors 12 in the describing various embodiments, the principles described herein may equally be applied to combustor groups having two or more combustors 12.

FIG. 5 is a schematic diagram of a gas turbine system 10 having a first group 130 of first combustors 132 (e.g., “A” combustors) and a second group 134 of second combustors 136 (e.g., “B” combustors) arranged in a pattern and separated from one another by an imaginary dividing line 138. Other groups of combustors 12 may also be disposed circumferentially 46 about the gas turbine system 10. One or more orifice plates 13 may be disposed in fuel paths coupled to a first circuit 140 and optionally in one or more of fuel paths coupled to a second circuit 142 to adjust the flow of the fuel 4, and therefore, the fuel split to one or more of the combustors 12, so that the combustion dynamics frequency of the first group 130 is different from the combustion dynamics frequency of the second group 134. The first circuit 140 may be any one of the fuel manifolds 106, 108, 110, or 114 shown in FIG. 4 and the second circuit 142 may be another one of the fuel manifolds 106, 108, 110, or 114 different from the first circuit 140. The fuel paths coupled to the first circuit 140 may be any one of the fuel paths 72, 74, 76, 94, 96, or 98 and the fuel paths coupled to the second circuit 142 may be another one of the fuel paths 72, 74, 76, 94, 96, or 98 different from the fuel paths coupled to the first circuit 140. Thus, the orifice plates 13 may be adjusted or tuned to achieve a desired combustion dynamics frequency. The orifice plates 13 of the first group 130 may be different from the orifice plates 13 of the second group 134. For example, the orifice plates of the first and second groups 130 and 134 may differ in the number of orifices, sizes of orifices, shapes of orifices, spacings between orifices, radial and/or circumferential distribution of orifices, angles of orifices, effective orifice areas, and so forth. In addition, the combustors 12 in the first and second groups 130 and 134 may be arranged in any desired spatial orientation (e.g., adjacent to one another or in an alternating pattern with combustors 12 of another group). Although orifice plates 13 are shown in both the first and second groups 130 and 134 in FIG. 5, in certain embodiments, the orifice plates 13 may be used with only the first group 130 or only the second group 134.

As shown in FIG. 5, the orifice plates 13 of the second group 134 may be disposed in the fuel paths coupled to the first circuit 140. The restriction to the flow rate of the fuel 4 through these fuel paths may cause an increased flow rate of the fuel 4 through the fuel paths coupled to the first circuit 140 of the first group 130. If the flow rates of the fuel 4 through the combustors 12 is not adjusted, the total fuel flow rate (e.g., sum of the various flow rates of the fuel 4 to a particular combustor 12) through the combustors 12 of the first group 130 may be greater than the total fuel flow rate through the combustors 12 of the second group 134 because of the increased flow rate of the fuel 4. In certain embodiments, such differences in the total fuel flow rate through the combustors 12 may cause differences in combustor performance, such as differences in combustor temperatures and/or combustor emissions (e.g., NOₓ). Thus, the orifice plates 13 may also be disposed in the fuel paths coupled to the second circuit 142 of the first group 130. Specifically, the orifice plates in these fuel paths of the first group 130 may cause a restriction to the flow rate of the fuel 4 through the fuel paths, which may cause an increased flow rate of the fuel 4 through the fuel paths coupled to the second circuit 142 of the second group 134. The decrease in the flow rate of the fuel 4 through the fuel paths coupled to the second circuit 142 of the first group 130 may be approximately the same as the increase in the flow rate of the fuel 4 through the fuel paths coupled to the first circuit 140 of the first group 130. Similarly, the decrease in the flow rate of the fuel 4 through the fuel paths coupled to the first circuit 140 of the second group 134 may be approximately the same as the increase in the flow rate of the fuel 4 through the fuel paths coupled to the second circuit 142 of the second group 134. Thus, by using orifice plates 13 in both the first and second groups 130 and 134, the total fuel flow rates to the combustors 12 may all be approximately the same (e.g., within a range, such as within 10%, 5%, 3%, 2%, 1%, or less than one another), thereby reducing differences in combustor performance. In certain embodiments, the orifice plates 13 in the first group 130 may be omitted. In further embodiments, orifice plates 13 may be disposed in the fuel paths coupled to both the first and second circuits 140 and 142 of both groups 130 and 134, and the orifice plates 13 disposed in the first group 130 may or may not be different from the corresponding orifice plates 13 disposed in the second group 134. Further, in any of the disclosed embodiments, some of the combustors 12 may not include orifice plates 13 in any of the fuel paths.

Technical effects of the invention include reducing combustion dynamics in combustors 12, reducing combustion dynamics and/or modal coupling of combustion dynamics between multiple combustors 12, and reducing potential unwanted vibratory responses in the gas turbine system 10 (e.g., due to combustion dynamics frequencies matching natural frequencies of components). The orifice plates 13 disposed in the fuel path 5 are able to achieve these technical effects by, for example, varying the flow rate of the fuel 4 to one or more combustors 12, thereby altering the fuel split to one or more combustors 12. For example, the orifice plates 13 of multiple combustors 12 can be varied by changing the following characteristics of the orifice plate 13 and/or the orifices of the plate 13: the geometric shape (e.g., angled, concaved, convexed, concavely angled, convexly angled, shaped similar to various polygons, irregularly shaped, irregularly angled, etc.), the geometric characteristics (e.g., dimensions, height, width, depth, length, degree of angle, angle characteristics, etc.), geometric arrangements (e.g., position, location, etc.), and/or any combination thereof. Varying the orifice plates 13 of one or more combustors 12 may change the inlet conditions of the fuel 4 routed to the combustion chamber 19 (e.g., from the outer and inner orifices 82 and 84 and/or the diffusion or pilot orifices 86), and may vary the combustion dynamics within the one or more combustors 12. In addition, in certain embodiments, additional orifice plates 13 may be used to adjust the flow rates of the fuel 4 through the combustors 12. Accordingly, the variability in combustion dynamics among the plurality of combustors 12 may help to reduce combustion dynamics and/or modal coupling of combustion dynamics between the combustors 12, thereby helping to reduce the possibility of any dominant frequencies that could potentially trigger unwanted vibratory responses in the gas turbine system 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas turbine engine comprising:
a first combustor comprising:
a first fuel nozzle disposed in a first head end chamber of the first combustor, wherein the first fuel nozzle comprises a first orifice configured to inject fuel into a first combustion chamber of the first combustor; and
a second combustor comprising:
a second fuel nozzle disposed in a second head end chamber of the second combustor, wherein the second fuel nozzle comprises a second orifice configured to inject the fuel into a second combustion chamber of the second combustor; and
a second orifice plate disposed in a fuel path upstream of the second orifice, wherein the second orifice plate is configured to help reduce modal coupling between the first combustor and the second combustor.

2. The system of claim 1, wherein the second orifice comprises at least one of an inner vane pack orifice, an outer vane pack orifice, a pilot orifice, a diffusion orifice, or any combination thereof.

3. The system of claim 1, comprising a first orifice plate disposed in the fuel path upstream of the first orifice.

4. The system of claim 3, wherein a first effective orifice area of the first orifice plate is different from a second effective orifice area of the second orifice plate.

5. The system of claim 3, wherein the first orifice plate has at least one difference relative to the second orifice plate.

6. The system of claim 5, wherein the at least one difference is configured to help reduce modal coupling between the first combustor and the second combustor.

7. The system of claim 5, wherein the first orifice plate is configured to at least partially control first combustion dynamics in the first combustor, wherein the second orifice plate is configured to at least partially control second combustion dynamics in the second combustor, and wherein the at least one difference between the first and second orifice plates causes differences between the first and second combustion dynamics.

8. The system of claim 5, wherein the at least one difference comprises at least one of different orifice diameters, different orifice shapes, different numbers of orifices, different geometrical arrangements of orifices, or different distances between adjacent orifices, or any combination thereof, between the first and second orifice plates.

9. The system of claim 1, wherein the second orifice plate is disposed outside of the second combustor and adjacent a second end cover of the second combustor.

10. The system of claim 1, comprising:
a first plurality of first combustors; and
a second plurality of second combustors, wherein the first and second pluralities of combustors are arranged in a pattern to help reduce modal coupling between the first plurality of first combustors and the second plurality of second combustors.

11. The system of claim 1, wherein the first combustor comprises:
a third fuel nozzle disposed in the first head end chamber of the first combustor, wherein the third fuel nozzle comprises a third orifice configured to inject fuel into the first combustion chamber of the first combustor, and
a third orifice plate disposed in the fuel path upstream of the third orifice, wherein the third orifice plate is configured to help reduce modal coupling between the first combustor and the second combustor.

12. A system, comprising:
a first combustor comprising:
a first fuel nozzle disposed in a first head end chamber of the first combustor, wherein the first fuel nozzle comprises a first orifice configured to inject a fuel into a first combustion chamber of the first combustor; and
a first orifice plate disposed in a fuel path upstream of the first orifice, wherein the first orifice plate is configured to at least partially control first combustion dynamics in the first combustor.

13. The system of claim 12, wherein the first orifice plate is configured to at least partially control at least one of a fuel flow rate, a fuel velocity, or any combination thereof, through the fuel path.

14. The system of claim 12, comprising a second combustor, wherein the second combustor comprises:
a second fuel nozzle disposed in a second head end chamber of the second combustor, wherein the second fuel nozzle comprises a second orifice configured to inject the fuel into a second combustion chamber of the second combustor; and
a second orifice plate disposed in the fuel path upstream of the second orifice, and the first and second orifice plates have at least one difference to vary the second combustion dynamics relative to the first combustion dynamics.

15. The system of claim 12, wherein the first combustor comprises:
a third fuel nozzle disposed in the first head end chamber of the first combustor, wherein the third fuel nozzle comprises a third orifice configured to inject fuel into the first combustion chamber of the first combustor, and
a third orifice plate disposed in the fuel path upstream of the third orifice, wherein the third orifice plate is configured to at least partially control first combustion dynamics in the first combustor.

16. A method, comprising:
injecting a fuel into a first combustion chamber of a first combustor from a first orifice of a first fuel nozzle disposed in a first head end chamber of the first combustor;
injecting the fuel into a second combustion chamber of a second combustor from a second orifice of a second fuel nozzle disposed in a second head end chamber of the second combustor; and
controlling second combustion dynamics in the second combustor with a second orifice plate disposed in a fuel path upstream of the second orifice, wherein the second orifice plate is configured to help reduce modal coupling between the first combustor and the second combustor.

17. The method of claim 16, comprising controlling first combustion dynamics in the first combustor with a first orifice plate disposed in the fuel path upstream of the first orifice, wherein the first orifice plate is configured to help reduce modal coupling between the first combustor and the second combustor.

18. The method of claim 17, comprising providing the first orifice plate with at least one difference from the second orifice plate to reduce modal coupling between the first and second combustors.

19. The method of claim 16, comprising:
injecting the fuel into the first combustion chamber of the first combustor from a third orifice of a third fuel nozzle disposed in the first head end chamber of the first combustor; and
controlling first combustion dynamics in the first combustor with a third orifice plate disposed in the fuel path upstream of the third orifice, wherein the third orifice plate is configured to help reduce modal coupling between the first combustor and the second combustor.

20. The method of claim 19, comprising maintaining a first total fuel flow to the first combustor within a range of a second total fuel flow to the second combustor using the first orifice plate, the second orifice plate, and the third orifice plate.
